(19) United States
(12) Patent Application Publication
(10) Pub. No.: US 2014/0244386 A1
(43) Pub. Date: Aug. 28, 2014

(54) TARGETING ADVERTISEMENTS TO LOGGED OUT USERS OF AN ONLINE SYSTEM

(71) Applicant: Facebook, Inc., Menlo Park, CA (US)

(72) Inventor: Nipun Mathur, Menlo Park, CA (US)

(73) Assignee: Facebook, Inc., Menlo Park, CA (US)

(21) Appl. No.: 13/777,857

(22) Filed: Feb. 26, 2013

(51) Int. Cl. G06Q 30/02

(52) U.S. Cl. CPC G06Q 30/0255
USPC 705/14.53

(57) ABSTRACT

An online system stores a plurality of browsing histories for its users, each browsing history associated with a user's user identifying information. Based on a request for an advertisement from a client device that identifies a user and indicates the user does not have an existing session with the online system, the online system compares the identified user's browsing history to other stored browsing histories. Users associated with stored browsing histories similar to the identified user's browsing history are identified and user profiles of the identified users having an established session with the online system are identified. One or more common characteristics of the identified user profiles are used to select an advertisement for presentation to the user.

### BACKGROUND

The present disclosure relates to advertising, and in particular to selecting and serving advertisements targeted to users of an online system while those users are not part of an online session with the online system.

Advertisement revenue provides an important revenue stream for many online systems, such as social networking systems. Targeting advertisements to particular social networking system users typically generates greater advertisement revenue for advertisers compared to broad-based ads because users typically perceive targeted advertisements as more relevant. By serving more relevant ads, advertisers increase the conversion rate of advertisement (“ad”) viewers purchasing the advertised goods or services, benefitting both the advertiser. This increase in advertisement effectiveness increases the amount of compensation the online system may receive from advertisers.

To improve an advertisement's relevance, advertisers use consumer data, such as websites visited or content viewed. However, this often fails to provide insight into other dynamics that can affect a consumer's purchasing decision. Hence, if limited to accessing a user's individual online purchasing activity, advertisers are unable to improve the relevance of their advertisements by leveraging other dynamics affecting a user's purchasing decision process.

Additionally, an increasing number of users access online systems and other online content using mobile devices. However, native applications on mobile devices used for accessing online content often do not maintain cookies or provide similar functionality for tracking and analyzing a user's activity on the mobile device. Even if a web browser on a mobile device maintains cookie tracking a user's browsing history, conventional native applications on the mobile device are unable to access these cookies, limiting the information available to the native applications. This inhibits native applications on a mobile device from delivering advertisements customized for a user.

### SUMMARY

Embodiments of the present disclosure enable a client application on a client device to request an advertisement from an online system, such as a social networking system, for presentation to a viewing user of the online system. The requested advertisement may be targeted to the viewing user even if the viewing user does not have a session with the online system when the advertisement is requested. The client application executing on the client device sends an advertisement request including user identification information associated with the viewing user and information indicating whether the viewing user has an established online session to the online system. A plurality of browsing histories, each associated with user identification information is maintained by the online system, allowing the online system to compare characteristics of the viewing user's browsing history with characteristics of browsing histories of other online system users. Based on the comparison, the online system selects a browsing history and identifies an advertisement for presentation to the viewing user based on the selected browsing history.

When a request for an advertisement is received, the online system retrieves a browsing history associated with the viewing user of the client device from the user identification information in the request. Based on the retrieved browsing history, the online system identifies one or more browsing histories of additional users and determines user identification information associated with the identified one or more browsing histories. The online system accesses user profiles associated with the user identification information associated with the identified one or more browsing to infer one or more characteristics of the viewing user from the accessed user profiles.

Based on the one or more characteristics inferred from the accessed use profiles, the online retrieves one or more candidate advertisements associated with one or more target characteristics satisfied by the inferred characteristics of the viewing user. Each candidate advertisement is also associated with a bid amount identifying the compensation received by the online system if the candidate advertisement is presented to the viewing user or if the candidate advertisement is accessed by the viewing user. From the bid amounts, the social networking system computes an expected value for each candidate advertisement and ranks the candidate advertisements using the expected values. Based on the ranking, an advertisement is selected and provided to the client device for presentation to the viewing user. As the viewing user interacts with the advertisement or with other content, the online system receives browsing data from the client device and updates the browsing history associated with the viewing user's user identification information accordingly.

### BRIEF DESCRIPTION OF THE DRAWINGS

FIG. 1 illustrates a block diagram of a system environment for targeting advertisements to users without an established session with an online system, in accordance with an embodiment.

FIG. 2 illustrates a block diagram of a system environment for serving an advertisement to users of an online system, in accordance with an embodiment.

FIG. 3 is an example block diagram of an architecture of a social networking system, in accordance with an embodiment.

FIG. 4 illustrates a flowchart of one embodiment of a process for selecting an advertisement for presentation to a user, in accordance with an embodiment.

The figures depict various embodiments of the present disclosure for purposes of illustration only. One skilled in the art will readily recognize from the following discussion that alternative embodiments of the structures and methods illustrated herein may be employed without departing from the principles of the embodiments described herein.

### DETAILED DESCRIPTION

### Overview

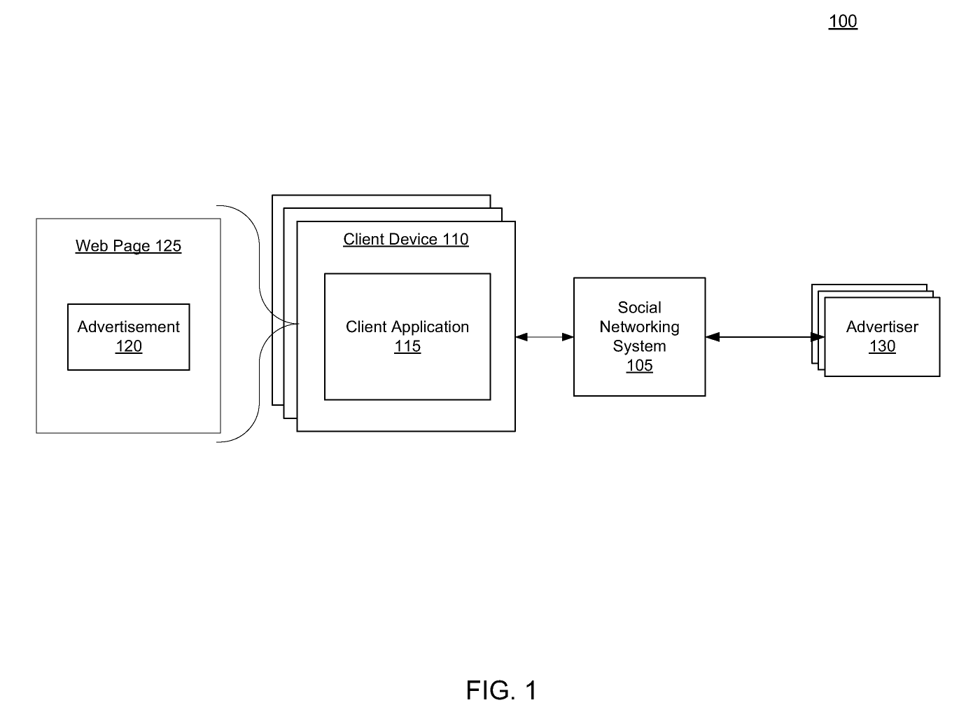

FIG. 1 illustrates a block diagram of one embodiment of a system environment 100 for targeting advertisements to online system users without an established session with the online system. In the example of FIG. 1, the online system is a social networking system 105, but it other embodiments any suitable online system maintaining information about its users may be included in the system environment. A user has an established or ongoing session with the social networking system 105 when the user is logged into the social networking system (e.g., has supplied correct login and password information). Hence, users may have an ongoing session with the social networking system 105 or may not have an ongoing session with the social networking system 105.

The system environment 100 shown by FIG. 1 includes a client device 110 including a client application 115, which may be any application presenting content to a user of the client device 110. Content presented by the client application 115 may include one or more advertisements 120. In some embodiments, the one or more advertisements 120 are presented to a user of the client device 110 via a web page 125. The client application 115 monitors the user's interaction with advertisements 120 and other content, including other pages containing advertisements 120 to create browsing data describing a user's interactions with content. In some embodiments, the client application 115 transmits a notification when an advertisement 120 is selected by the user or when the user views content including an advertisement 115. A notification may include, for example, a user's browsing data, a user's identification (“ID”) information, or both. Browsing data includes information about web pages or other content accessed by the user, advertisements selected by the user, or some combination thereof. The user ID information is associated with a user profile associated with the user and maintained by the social networking system 105. As further described below, the user ID information may be used to determine if the user has an existing session with the social networking system 105.

The social networking system 105 maintains browsing histories for various users based on browsing data from a plurality of client devices 110. Browsing histories for users associated with various client devices are compiled and stored along with corresponding user ID information received from the various client devices 110. Stored browsing histories may include one or more browsing histories for users with ongoing sessions with the social networking system 105 as well as one or more browsing histories for users that do not have ongoing sessions with the social networking system 105. A client device 110 associated with a user may send a request for an advertisement to the social networking system 105. If the user associated with the client device 110 has an ongoing session with the social networking system 105, user profile information associated with the user may be accessed by the social networking system 105 as well as the user's stored browsing history. In this case, the social networking system 105 may select advertisements for presentation to the user based on information in the user's user profile. In contrast, if the user associated with the client device 110 does not have an ongoing session with the social networking system 105, user profile information associated with the user cannot be accessed by the social networking system 105. To provide advertisements more relevant to a user that does not have an ongoing session, the social networking system 105 compiles browsing data received from the client device 110 associated with the user to develop and/or update a browsing history (also known as an “anonymous” browsing history) associated with the user ID information of the user without access to the user's profile. The social networking system 105 uses the anonymous browsing history and browsing histories of other users of the social networking system 105 to identify an advertisement targeted to the user associated with the client device 110.

The client application 115 may request advertisements from the social networking system 105 for presentation to the user. A request for an advertisement includes user ID information for the user associated with the client device 110 (the “viewing user”) and information (e.g., a cookie) indicating whether the viewing user has an existing session with the social networking system 105. In some embodiments, the request for an advertisement may additionally include one or more request parameters specifying conditions which the social networking system 105 may use to limit advertisements provided to the client application 115. For example, a request parameter causes the social networking system 105 to select advertisements that have not been previously displayed to the viewing user.

When receiving the request for the advertisement from the client device, the social networking system 105 retrieves a browsing history (or a portion thereof) associated with the user ID information included in the received request. For example, the social networking system 105 retrieves a stored browsing history associated with the user ID information. If the request includes information indicating the user has an ongoing session with the social networking system 105, information from a user profile associated with the user ID information is retrieved and used to select an advertisement targeted to the viewing user. An example process for selecting and providing targeted advertisements for users with existing sessions with an online system is disclosed in U.S. patent application Ser. No. 13/689,160, filed on Nov. 29, 2012, which is hereby incorporated by reference in its entirety. However, if the request indicates the user does not have an ongoing session with the social networking system 105, the social networking system 105 retrieves an anonymous browsing history associated with the user ID information.

The social networking system 105 identifies one or more browsing histories of other social networking system users based on the anonymous browsing history associated with the user ID information in the request. In one embodiment, the social networking system 105 compares the anonymous browsing history with one or more browsing histories of other users of the social networking system 105 to determine shared features and/or attributes (e.g., commonalities) between the anonymous browsing history and the other stored browsing histories. In alternative embodiments, the social networking system 105 identifies one or more browsing histories of other users of the social networking system 105 having an established session to the social networking system 105 and having commonalties with the anonymous browsing history associated with the user ID information in the request.

The social networking system 105 scores the browsing histories that were compared to the anonymous browsing history. For example, the browsing histories may be scored by the amount of commonalties, or other overlap, with the anonymous browsing history associated with the user ID information from the request. In one embodiment, the social networking system 105 then identifies stored browsing histories with scores over a threshold value. In some embodiments, the threshold value is set by an administrator. In alternate embodiments, the social networking system 105 automatically sets the threshold value.

For example, the anonymous browsing history may indicate that the user associated with the user ID information in the request browses websites for luxury watches (e.g., ROLEX®). The social networking system 105 compares the anonymous browsing history with stored browsing histories (e.g., A, B, and C) of other users of the social networking system 105. Browsing history A may indicate an interest in OMEGA® watches, luxury travel, and finance. Browsing history B may indicate an interest in BREITLING® watches and expensive cars. And browsing history C may indicate an interest in CASIO® calculator watches and camping. In one embodiment, the social networking system 105 comparing the three browsing histories to the anonymous browsing history would score browsing histories A and B higher than browsing history C as are more commonalities between the anonymous browsing history and browsing histories A and B than between the anonymous browsing history and browsing history C (e.g., ROLEX®, BREITLING®, and OMEGA® are all luxury watches). If the score of browsing history C is less than the threshold value, the social networking system 105 selects browsing histories A and B for additional analysis.

The social networking system 105 determines user ID information associated with the identified one or more browsing histories. Each identified browsing history is associated with user ID information corresponding to a social networking system user. User profile information associated with user ID information associated with the identified browsing histories and with user ID information indicating an existing session with the social networking system 105 is retrieved by the social networking system 105. Hence, the social networking system 105 retrieves user profile information for users having an existing session with the social networking system 105 and associated with the user ID information of the identified browsing histories.

From the user profiles associated with the user ID information associated with the identified browsing histories and having an existing session with the social networking system 105, one or more common characteristics of the user profiles are determined. A characteristic is a feature or quality associated with a particular user profile. Examples of characteristics are indications of wealth, occupation, occupation field (e.g., medicine, engineering, etc.), hobbies, user interests, geographic location, gender, age, some other demographic, etc. The social networking system 105 compares characteristics of the user profiles to determine one or more characteristics that are common to at least a threshold number, or common to all, of the retrieved user profiles. Continuing with the above example, browsing histories A and B are associated with user profile A and user profile B, respectively. The social networking system 105 compares user profile A and user profile B to identify one or more common characteristics between the user profiles. For example, the user profile A and user profile B include characteristics indicating that both users are surgeons, travel extensively, and enjoy high-end watches. Thus, the social networking system 105 determines the common characteristics to be “doctor,” “medical field,” “wealthy,” “enjoy luxury travel,” and “like high-end watches.”

Additionally, the social networking system maintains various candidate advertisements. The candidate advertisements may be received from one or more advertisers 130 or may be generated by the social networking system 105. Each candidate advertisement is associated with a bid price and may be associated with one or more targeting criteria specifying one or more characteristics of users eligible to be presented with the candidate advertisement.

From the candidate advertisements, the social networking system 105 selects an advertisement associated with one or more targeting criteria satisfied by the determined one or more characteristics. For example, an advertisement associated with targeting criteria matching at least one of the determined characteristics is selected. As another example, the social networking system 105 determines expected values for each of the candidate advertisements, or of the candidate advertisements associated with targeting criteria satisfied by one or more of the determined characteristics, based on their bid prices and a likelihood of the candidate advertisement being accessed. Based on the auction, the social networking system 105 selects an advertisement, such as the candidate advertisement with the highest expected value, to send to the client device 110. The social networking system 105 provides the selected advertisement to the client application 115, which presents the selected advertisement to the viewing user. For example, the client application 115 displays the selected advertisement to the user, plays audio associated with the selected advertisement for the user, or otherwise presents the selected advertisement to the user.

In some embodiments, the social networking system 105 may select the advertisement based in part on information about advertisements that have been presented to the viewing user when there is no established session with the social networking system 105. This information may increase the likelihood that the selected advertisement is from an advertiser with which the viewing user previously interacted when there was not an established session with the social networking system 105, allowing advertisements to be retargeted based on content viewed by the viewing user via the client device 110.

### System Architecture

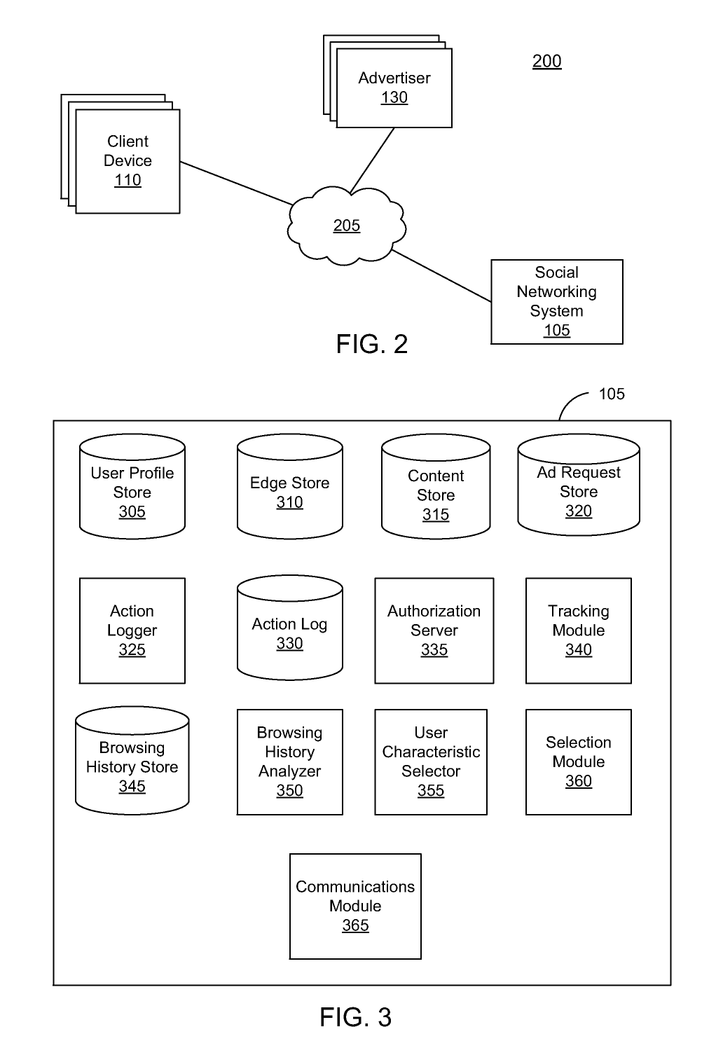

FIG. 2 illustrates a block diagram of one embodiment of a system environment 200 for serving advertisements to online system users. The system environment 200 includes one or more client devices 110, the social networking system 105, one or more advertisers 130, and a network 205. In various embodiments, the system environment 200 may be organized in an alternative topology or configuration, and include different and/or additional modules. While FIG. 2 shows a social networking system 105, in other embodiments any suitable online system maintaining information about its users may be included in the system environment 200.

The client devices 110 comprise one or more computing devices capable of processing data as well as transmitting and/or receiving data via the network 205. Examples of a client device 110 include a mobile device and a desktop computer. A mobile device may be, for example, a mobile telephone, a smart phone, a tablet computer, a laptop computer, or some other portable device presenting content, which may include advertisements. A client device 110 may execute a social networking application that allows a social networking system user to exchange data with the social networking system 105 via a client device 110 and the network 205. Alternatively, a social networking system user accesses the social networking system 105 via a browser executing by the client device 110. User ID information for each user of the requesting device 110 that previously accessed the social networking system 105 may be stored by the client device 110.

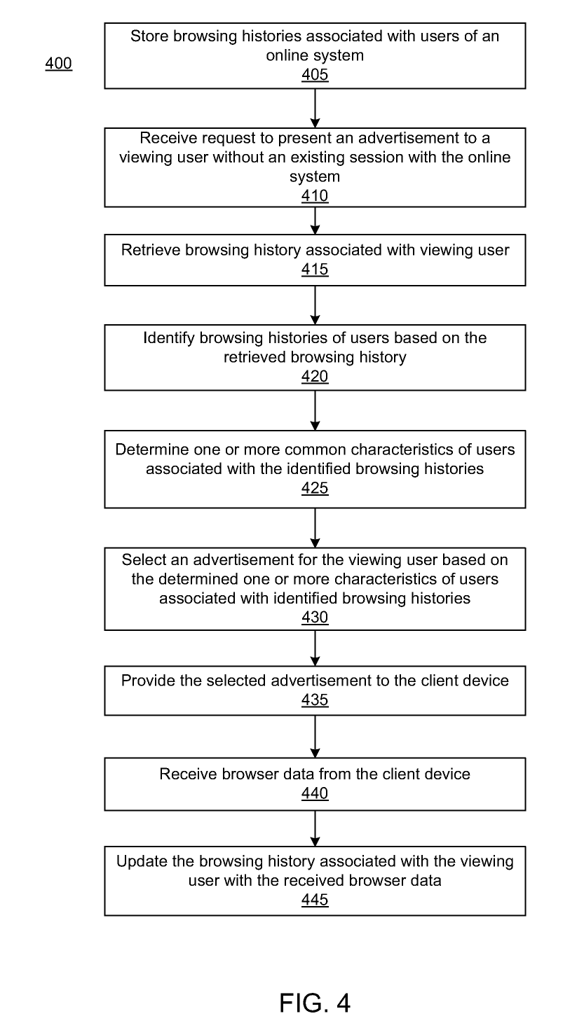

The advertisers 130 provide advertisements or data for generating advertisements to entities in system environment 200. For example, an advertiser 130 generates one or more advertisement (“ad”) requests each including a bid price, one or more targeting criteria, and advertisement content for presentation. An advertiser may communicate ad requests to the social networking system 105, which selects advertising request presented via the client device 110, as further described below in conjunction with FIGS. 3 and 4.

The client devices 110 are configured to communicate with the social networking system 105 and/or other devices via the network 205. In one embodiment, the network 205 uses standard communications technologies and/or protocols. Thus, the network 205 may include wired and/or wireless communication channels using technologies such as Ethernet, 802.11 family of standards, worldwide interoperability for microwave access (WiMAX), 3G, 4G, CDMA, digital subscriber line (DSL), etc. Examples of networking protocols used by the network 205 include multiprotocol label switching (MPLS), the transmission control protocol/Internet protocol (TCP/IP), the User Datagram Protocol (UDP), the hypertext transport protocol (HTTP), the simple mail transfer protocol (SMTP), and the file transfer protocol (FTP). The data exchanged over the network 205 can be represented using technologies and/or formats including the hypertext markup language (HTML) and the extensible markup language (XML). In addition, all or some of the communication channels may be encrypted using conventional encryption technologies such as secure sockets layer (SSL), transport layer security (TLS), and Internet Protocol security (IPsec).

FIG. 3 is an example block diagram of an architecture of the social networking system 105. In the embodiment shown by FIG. 3, the social networking system 105 includes a user profile store 305, an edge store 310, a content store 315, an ad request store 320, an action logger 325, an action log 330, an authorization server 335, a tracking module 340, a browsing history store 345, a browsing history analyzer 350, a user characteristic selector 355, a selection module 360, and a communications module 365. In other embodiments, the social networking system 105 may include additional, fewer, or different modules for various applications. Conventional components such as network interfaces, security functions, load balancers, failover servers, management and network operations consoles, and the like are not shown so as to not obscure the details of the system architecture.

User account information and other related information for users are stored as user profiles in user profile store 305. For example, each user of the social networking system 105 is associated with a unique user identifier. The user identifier is stored in a user profile maintained by the user profile store 305. Examples of a user identifier include logins and passwords or other data uniquely identifying users. When a user provides identifying information, such as a login and password, to the social networking system 105, the user has an established, or ongoing, session with the social networking system 105 and the social networking system 105 retrieves a user profile associated with the retrieved identifying information. For example, the user profile store 305 includes a lookup table for retrieving a user profile associated with user identifying (“ID”) information received from a client device 110.

Information stored in a user profile describes a social networking system user. Examples of information stored in a user profile include: biographic, demographic, and other types of descriptive information, such as work experience, educational history, gender, hobbies or preferences, location, and the like. User profile information may also store other information provided by the user, for example, images or videos. In certain embodiments, images of users may be tagged with information identifying users of the social networking system 105 displayed in an image. The user profile store 305 may also maintain references to actions stored in the action log 330 and performed on objects in the content store 315. A user profile may also include information indicating whether a user corresponding to the user profile has an established session with the social networking system 105.

The edge store 310 stores information describing connections between users and other objects on the social networking system 105 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 105, such as expressing interest in a page on the social networking system 105, sharing a link with other users of the social networking system 105, and commenting on posts made by other users of the social networking system 105.

The edge store 310 also includes information about edges, such as affinity scores for objects, interests, and other users. Affinity scores may be computed by the social networking system 105 over time to approximate a user's affinity for an object, interest, and other users in the social networking system 105 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. In one embodiment, multiple interactions between a user and a specific object may be stored in one edge in the edge store 310, in one embodiment. For example, a user that plays multiple songs from Miles Davis' album, “Kind of Blue,” may have multiple edges between the user and different songs, but a single edge between the user and an object for Miles Davis. Alternatively, multiple interactions between a user and an object may be combined into a single edge.

The content store 315 stores content items associated with a user profile, such as images, videos, and audio files, as objects. Content items from the content store 315 may be displayed when a user profile is viewed or when other content associated with the user profile is viewed. For example, displayed content items show images or video associated with a user profile or text describing a user's status. Additionally, other content items may facilitate user engagement by encouraging a user to expand his connections to other users, to invite new users to the social networking system 105, or to increase interaction with the social networking system 105 by displaying content related to users, objects, activities, or functionalities of the social networking system. Examples of content items facilitating user engagement include suggested connections or suggestions to perform other actions, media provided to, or maintained by, the social networking system 105 (e.g., pictures or videos), status messages or links posted by users to the social networking system 105, events, groups, pages (e.g., representing an organization or commercial entity), and any other content provided by or accessible via the social networking system 105.

In one embodiment, ad requests are stored in the ad request store 320; however, in other embodiments, ad requests may be stored in the content store 315. Advertisements may be received from an advertiser 130 and/or an ad exchange. Additionally, the social networking system 105 may generate ad requests. An ad request includes a bid price and advertisement content (or an “advertisement”). Additionally, an ad request may also include one or more targeting criteria specifying characteristics of users eligible to be presented the advertisement. The bid price specifies an amount of compensation an advertiser 130 provides to the social networking system 105 for presenting the advertisement to a user, for receiving a user interaction with the advertisement, or based on any other suitable criteria. For example, the bid price specifies a monetary amount that the social networking system 105 receives from the advertiser 130 if the advertisement is displayed and the expected value is determined by multiplying the bid price by a probability of the advertisement being accessed. The bid price may be used to determine an expected value to the social networking system 105 for presenting an advertisement to a user. For example, an expected value of an ad request is generated based on the ad request's bid price and a likelihood of a user interacting with the ad request's advertisement. To estimate the likelihood of a user accessing an advertisement, the social networking system 130 may use the user's affinities for targeting criteria or for other objects associated with the advertisement.

Data about advertisers 130 associated with ad requests may also be used when computing the expected value of ad requests. For example, the number of users targeted by the advertiser 130 may affect the bid price, allowing ad requests from an advertiser 130 having a lower bid amount but a larger group of potentially accessible users to have a higher expected value than ad requests from an advertiser 130 having a higher bid amount but a smaller group of potentially accessible users. The expected value may be weighted by the amount of common data between an ad request's targeting criteria and a user's characteristics, so that ad requests more likely to be accessed by the user have a higher expected value. In some embodiments, the expected values of ad requests may be adjusted based on whether the user has previously viewed content from advertisers 130 associated with the ad requests, or has interacted with advertisements or other objects associated with advertisers associated with the ad requests.

The action logger 325 receives communications about user actions on and/or off the social networking system 105 and populates the action log 330 with information about user actions. Examples of actions include: adding a connection to another user, sending a message to another user, uploading an image, reading a message from another user, viewing content associated with another user, attending an event posted by another user, among others. In addition, a number of actions described in connection with other objects are directed toward particular users, so these actions are associated with those users as well. These actions are stored in the action log 330.

Users may interact with various objects on the social networking system 105, including commenting on posts, sharing links, and checking-in to physical locations via a client device 110, or other interactions. Information describing these interactions, or “actions,” is captured by the action logger 325 and stored in the action log 330. Additional examples of interactions with objects on the social networking system 105 included in the action log 330 include commenting on a photo album, sending communications to another user, adding an event to a calendar, joining a group, becoming a fan of a brand page, creating an event, authorizing an application, using an application, and engaging in a transaction. Additionally, the action log 330 records a user's interactions with advertisements on the social networking system 105 as well as other applications operating on the social networking system 105.

The action log 330 may also store user actions taken on external websites. For example, an e-commerce website that primarily sells sporting equipment at bargain prices may recognize a user of a social networking system 105 through social plug-ins that enable the e-commerce website to identify the user of the social networking system 105. Because social networking system users are uniquely identifiable, e-commerce websites, such as this sporting equipment retailer, may use the information about these users as they visit their websites. The action log 330 records data about these users, including webpage viewing histories, advertisements that were engaged, purchases made, and other patterns from shopping and buying.

The authorization server 335 enforces one or more privacy settings of social networking system users. A privacy setting associated with a user determines how particular information associated with a user may be shared. The privacy setting comprises a specification of particular information associated with a user and a specification of the entity or entities with which the information can be shared. Examples of entities with which information can be shared include other users, applications, advertisers 130, or any entity that may potentially access the information. Examples of information associated with a user that may be shared include: a profile photo, one or more phone numbers associated with the user, other users connected to the user, actions performed by the user, changes to the user's profile, or other information associated with the user's user profile.

The authorization server 335 includes logic to determine if certain information associated with a user may be used by the browsing history analyzer 350 and the user characteristic selector 355 to select advertisements for presentation to users without an existing session with the social networking system 105. Based on a user's privacy settings, the authorization server 335 may prevent the social networking system 105 from accessing the user's browsing history and/or user profile to determine characteristics for advertisement selection. Hence, privacy settings allow a social networking system user to control use of and access to its user profile information, browsing history, and other information.

The tracking module 340 receives information from one or more client devices 110 describing content accessed by a social networking system user via a client device. For example, the tracking module 340 receives browsing data describing web pages or other content accessed from a plurality of client devices 110 via the communications module 365. Based on the received browsing data, the tracking module 340 generates or modifies browsing histories associated with various users, which are stored in the browsing history store 345. Additionally, from the information received from a client device 100, the tracking module 340 determines whether a user associated with the client device 110 has an ongoing session with the social networking system 105. If a user has an ongoing session, the tracking module 340 may update the user's associated user profile with the information received from the client device 110 and updates the user's corresponding browsing history in the browsing history store 345. In contrast, if a user does not have an ongoing session, the tracking module 340 is unable to access its associated user profile, so the tracking module 340 aggregates received information associated with a user to develop an anonymous browsing history without access to the user's profile. The tracking module 340 stores the anonymous browsing histories in the browsing history store 345.

The browsing history store 345 includes browsing histories for various users of the social networking system 105. A browsing history associated with a user identifies content previously accessed by the user via one or more client devices 110. Browsing histories may be stored for users having an ongoing session with the social networking system 105 as well as for users that do not have an ongoing session with the social networking system 105.

The browsing history analyzer 350 retrieves browsing histories based on requests for advertisements received from client devices 110. In one embodiment, a request for an advertisement includes user ID information associated with the user of the requesting client device 110 and information indicating whether the user has an existing session with the social networking system 105. If the user corresponding to the user ID information has an ongoing session, the social networking system 105 may access the user profile corresponding to the user ID information to retrieve information about the user for selecting an advertisement. An example of a process for selecting and providing targeted advertisements to users having existing sessions with the social networking system 105 is further disclosed in U.S. patent application Ser. No. 13/689,160, filed on Nov. 29, 2012, which is hereby incorporated by reference in its entirety. In contrast, if the information in the request for an advertisement indicates the user does not have an ongoing session, the social networking system 105 retrieves an anonymous browsing history from the browsing history store 345 associated with the user ID information included in the request.

When a user does not have an existing session with the social networking system 105, the browsing history analyzer 350 identifies one or more browsing histories of additional social networking system users based on the anonymous browsing history associated with the user ID information in the request. In one embodiment, browsing history analyzer 350 compares the anonymous browsing history associated with the received user ID information with one or more browsing histories of other users of the social networking system 105 to determine common features and/or attributes (e.g., commonalities) between the anonymous browsing history associated with the received user ID information and the other browsing histories. In alternative embodiments, the browsing history analyzer 350 identifies one or more browsing histories of other users of the social networking system 105 having an established session to the social networking system 105 based on the anonymous browsing history. In some embodiments, the browsing history analyzer 350 generates scores describing the similarities between the anonymous browsing history associated with the received user ID information and browsing histories of other social networking system users. For example, a score associated with a browsing history is based on the amount of common characteristics between the anonymous browsing history and the browsing history. The browsing history analyzer 350 may select browsing histories associated with scores having at least a threshold value and communicates the selected browsing histories to the user characteristic selector 355.

The user characteristic selector 355 determines user ID information associated with the one or more browsing histories selected by the browsing history analyzer 350. In one embodiment, the user characteristic selector 355 determines whether a user associated with a selected browsing history has an established session with the social networking system 105. If the user associative with a selected browsing history has an established session with the social networking system 105, the user characteristic selector 355 retrieves user profile information associated with the user from the user profile store 305. Alternatively, the browsing history analyzer 350 determines whether users have an existing session with the social networking system 105 and communicates user ID information of users having an existing session with the social networking system 105 to the user characteristic selector 355.

From the user profiles associated with the user ID information of users associated with selected browsing histories and having an established session with the social networking system 105, the user characteristic selector 355 determines one or more common characteristics. A characteristic is a feature or quality associated with a particular user profile. Examples of characteristics indicate wealth, occupation, occupation field (e.g., medicine, engineering, etc.), hobbies, user interests, geographic location, gender, age, some other demographic, etc. For example, the user characteristic selector 355 identifies characteristics in a threshold number or in a threshold percentage of the user profiles as common characteristics. In other embodiments, the user characteristic selector 355 may use any suitable method for identifying common characteristics based on the user profiles. The user characteristic selector 355 may maintain associations between various characteristics to account for related characteristics when identifying common characteristics.

The selection module 360 selects an advertisement for presentation to the viewing user based on the one or more common characteristics determined by the user characteristic selector 355. The selection module 360 compares the determined common characteristics with one or more targeting criteria associated with ad requests and selects one or more candidate ad requests having one or more targeting criteria satisfied by the common characteristics. In one embodiment, the selection module 360 retrieves ad requests from the ad request store 320 and/or from the content store 315.

In some embodiments, the selection module 360 ranks ad requests having targeting criteria satisfied by one or more of the common characteristics (“candidate ad requests”) based on the bid prices or expected values associated with the candidate ad requests. For example, the selection module 360 performs an auction using the expected values of the candidate ad requests to select an advertisement. As described above, an expected value of a candidate ad request is based on its associated bid price and the likelihood of the viewing user accessing an advertisement associated with the candidate ad request. In some embodiments, the selection module 360 uses the bid price of a candidate advertisement as its expected value. Based on the expected values of the candidate ad requests, the selection module 360 ranks the candidate ad objects and uses the ranking to select an ad request having the advertisement for presentation to the viewing user (e.g., select the advertisement with the highest ranking)

If an advertisement request includes one or more request parameters, the selection module 360 filters the candidate ad requests using the request parameters before ranking the candidate ad requests. Examples of criteria specified by request parameters include: a specified size of the advertisement, a threshold number of times an advertisement in has been provided to the requesting client device 110 by the social networking system 105, a threshold expected value associated with ad requests, content of the advertisement, whether an advertisement has been previously presented to the requesting client device 110, or some combination thereof

If the determined one or more common characteristics satisfy targeting criteria of more than a threshold number of ad requests, the selection module 360 may select one or more common characteristics and rank ad requests having targeting criteria satisfied by the selected common characteristics. The selection module 360 may select the common characteristics based on targeting criteria of ad requests having various attributes. For example, targeting criteria of ad requests having the highest average expected value, of ad requests having the highest or lowest frequency of display, of ad requests having content for which the user has a threshold affinity, or any other suitable criteria may be selected. In other embodiments, the selection module 360 may select an ad request without filtering or limiting the candidate ad requests from which the ad request is selected.

The communications module 365 is configured to transmit and receive data between the social networking system 105 and the client device 110, advertisers 130, or some combination thereof using the network 205. The communications module 365 receives information from one or more client devices 110 and communicates the received information to components of the social networking system 105. For example, the communications module 365 receives requests for advertisements, notifications, user ID information, browser data, information indicating whether a user has an existing session with the social networking system 105, or other information and communicates the information to various components of the social networking system 105. In some embodiments, the communications module 365 receives, via the network 205, one or more ad requests from advertisers 130. The communications module 365 also communicates information from the social networking system 105, such as an advertisement from a selected ad request, to a client device 110 via the network 205.

### Selection of Advertisement Content for Client Device Users

FIG. 4 illustrates a flowchart of one embodiment of a process 400 for selecting an advertisement for presentation to a user of an online system. While FIG. 4 describes selection of an advertisement for a user of a social networking system 105, any other suitable online system maintaining information about its users may be used. The social networking system stores 405 browsing histories associated with its users. A browsing history associated with a user describes content, such as web pages, accessed by the user.

The social networking system 105 receives 410 a request to present an advertisement to a viewing user that does not have an existing session with the social networking system 105. In one embodiment, the request includes user ID information associated with the viewing user and information indicating whether the viewing user has an existing session with the social networking system 105. The request may further include one or more request parameters as described above.

Using the user ID information included in the request, the social networking system 105 retrieves 415 a browsing history associated with the viewing user. For example, the social networking system 105 retrieves a browsing history associated with the user ID information of the viewing user included in the request from a browsing history store 345 that is part of the social networking system 105. Using the browsing history associated with the viewing user, the social networking system 105 identifies 420 similar browsing histories of additional users. In one embodiment, the social networking system 105 determines common attributes of the browsing history associated with the viewing user and browsing histories of the additional users and identifies 420 browsing histories associated with additional users having at least a threshold number or percentage of attributes in common with the browsing history associated with the viewing user. For example, the social networking system 105 scores the similarity between the browsing history associated with the viewing user and the browsing histories associated with additional users and identifies 420 browsing histories associated with additional users having at least a threshold score.

Based on the identified browsing histories associated with the additional users, the social networking system 105 determines 425 one or more common characteristics of users associated with the identified browsing histories. The social networking system 105 determines user ID information associated with the identified browsing histories associated with additional users that have an existing session with the social networking system 105 and retrieves user profile information associated with the user ID information of the additional users. The social networking system 105 analyzes the user profiles to identify characteristics common to at least a threshold number of user profiles or to at least a threshold percentage of user profiles. Characteristics included in a threshold number or percentage of user profiles are determined 425 to be common characteristics. In other embodiments, any other suitable method for identifying common characteristics of the user profiles is used.

The social networking system 105 selects 430 an advertisement for the viewing user based on common characteristics of the user profiles associated with the users having an existing session with the social networking system 105 and associated with the identified browsing histories. Ad requests having one or more targeting criteria satisfied by the common characteristics are identified as candidate ad requests. In one embodiment, the social networking system 105 generates an expected value for each of the candidate ad requests based in part on the bid prices of the candidate ad requests, as described above, and ranks the candidate ad requests based on the expected values. As discussed above, the request for an advertisement may include one or more request parameters, and the candidate advertisements may be filtered based on the request parameters. Based on the ranking, an ad request including an advertisement is selected 430 and retrieved from the ad request store 320. The social networking system 105 then provides 435 the selected advertisement to the client device 110.

Additionally, the social networking system 105 receives 440 browser data from the client device 110 and updates the browsing history associated with the viewing user with the received browsing data. For example, if the viewing user interacts with the selected advertisement, the viewing user's browsing history is updated accordingly. This allows the social networking system 105 to maintain a current browsing history describing content with which the viewing user interacts.

### Summary

The foregoing description of the embodiments has been presented for the purpose of illustration; it is not intended to be exhaustive or to limit the disclosure to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the embodiments be limited not by this detailed description, but rather by any claims that issue on an application based hereon. Accordingly, the disclosure of the embodiments is intended to be illustrative, but not limiting, of the scope of the disclosure, which is set forth in the following claims.

What is claimed is:

1. A method comprising:
storing a plurality of browsing histories for users of an online system, each browsing history associated with user identifying information for a user of the online system;
receiving a request to present an advertisement to a viewing user of the online system from a client device, the request including user identifying information for the viewing user and indicating whether the viewing user has an existing session with the online session;
retrieving a browsing history associated with the user identifying information for the viewing user;
identifying one or more browsing histories of users of the online system based on the browsing history associated with the user identifying information for the viewing user if the request indicates the viewing user does not have the existing session with the online system;
determining user identifying information associated with the identified one or more browsing histories;
retrieving user profiles associated with the user identifying information associated with the identified one or more browsing histories and associated with users having an ongoing session with the online system
determining one or more common characteristics from the retrieved user profiles;
selecting an ad request from one or more candidate ad requests for presentation to the viewing user based on the determined one or more common characteristics; and
sending an advertisement associated with the selected ad request to the client device for presentation to the viewing user.

2. The method of claim 1, further comprising:
receiving browsing data identifying content accessed by the viewing user and the user identifying information for the viewing user from the client device; and
updating the browsing history associated with the user identifying information for the viewing user based on the received browsing data.

3. The method of claim 1, wherein identifying one or more browsing histories of users of the online system based on the browsing history associated with the user identifying information for the viewing user comprises:
generating scores for each of one or more browsing histories associated with one or more additional users of the online system, a score describing a degree of similarity between the browsing history associated with the user identifying user for the viewing user and a browsing history associated with an additional user of the online system; and
identifying one or more browsing histories associated with additional users of the online system having at least a threshold score.

4. The method of claim 3, wherein the one or more additional users of the online system have an existing online session with the online system.

5. The method of claim 3, wherein the one or more users have authorized the online system to access their browsing histories.

6. The method of claim 1, wherein identifying one or more browsing histories of users of the online system based on the browsing history associated with the user identifying information for the viewing user comprises:
identifying browsing histories of additional users of the online system having at least a threshold number of attributes in common with the browsing history associated with the user identifying information for the viewing user.

7. The method of claim 1, wherein identifying one or more browsing histories of users of the online system based on the browsing history associated with the user identifying information for the viewing user comprises:
identifying browsing histories of additional users of the online system having at least a threshold percentage of attributes in common with the browsing history associated with the user identifying information for the viewing user.

8. The method of claim 1, wherein determining one or more common characteristics from the retrieved user profiles comprises:
identifying characteristics included in at least a threshold number of the retrieved user profiles.

9. The method of claim 1, wherein determining one or more common characteristics from the retrieved user profiles comprises:
identifying characteristics included in at least a threshold percentage of the retrieved user profiles.

10. The method of claim 1, wherein the request includes at least one request parameter for filtering candidate ad requests identified by the online system.

11. The method of claim 1, wherein selecting the ad request from one or more candidate ad requests for presentation to the viewing user based on the determined one or more common characteristics comprises:
selecting one or more candidate ad requests having at least one targeting criteria satisfied by the one or more common characteristics;
calculating an expected value for each of the selected candidate ad requests based at least in part on a bid price associated with a selected candidate ad request; and
selecting a candidate ad request based at least in part on the expected values.

12. A method comprising:
receiving a request to present an advertisement to a viewing user of an online system from a client device, the request including user identifying information for the viewing user and indicating the viewing user does not haves an existing session with the online system;
retrieving a browsing history associated with the viewing user based on the user identifying information for the viewing user;
identifying one or more browsing histories associated with additional users of the online system and stored by the online system based on the browsing history associated with the viewing user;
retrieving user profile information associated with the additional users associated with the identified one or more browsing histories and having an ongoing session with the online system;
determining one or more common characteristics from the retrieved user profiles;
selecting an ad request having one or more targeting criteria satisfied by the one or more common characteristics; and
sending an advertisement associated with the selected ad request to the client device for presentation to the viewing user.

13. The method of claim 12, wherein identifying one or more browsing histories associated with additional users of the online system and stored by the online system based on the browsing history associated with the viewing user comprises:
generating scores for each of one or more browsing histories associated with one or more additional users of the online system, a score describing a degree of similarity between the browsing history associated with the user identifying user for the viewing user and a browsing history associated with an additional user of the online system; and
identifying one or more browsing histories associated with additional users of the online system having at least a threshold score.

14. The method of claim 12, wherein the additional users of the online system have an existing online session with the online system.

15. The method of claim 12, wherein the one or more users have authorized the online system to access their browsing histories.

16. The method of claim 12, wherein identifying one or more browsing histories associated with additional users of the online system and stored by the online system based on the browsing history associated with the viewing user comprises:
identifying browsing histories of additional users of the online system having at least a threshold number of attributes in common with the browsing history associated with the user identifying information for the viewing user.

17. The method of claim 12, wherein identifying one or more browsing histories associated with additional users of the online system and stored by the online system based on the browsing history associated with the viewing user comprises:
identifying browsing histories of additional users of the online system having at least a threshold percentage of attributes in common with the browsing history associated with the user identifying information for the viewing user.

18. The method of claim 12, wherein determining one or more common characteristics from the retrieved user profiles comprises:
identifying characteristics included in at least a threshold number of the retrieved user profiles.

19. The method of claim 12, wherein determining one or more common characteristics from the retrieved user profiles comprises:
identifying characteristics included in at least a threshold percentage of the retrieved user profiles.

20. The method of claim 12, wherein the request includes at least one request parameter for filtering candidate ad requests identified by the online system.
